(19) United States
(12) Patent Application Publication
(10) Pub. No.: US 2024/0175341 A1
(43) Pub. Date: May 30, 2024

(54) Fracing System with Threaded Block Connector and Variable Length Connector

(71) Applicant: Edge Mechanical Design Inc., Red Deer (CA)

(72) Inventor: Daine Strankman, Red Deer (CA)

(21) Appl. No.: 18/523,835

(22) Filed: Nov. 29, 2023

Related U.S. Application Data
(60) Provisional application No. 63/428,726, filed on Nov. 29, 2022.

(51) Int. Cl. E21B 43/26; E21B 17/08; F16L 15/00

(52) U.S. Cl. CPC E21B 43/26; E21B 17/08; F16L 15/006; E21B 2200/01

(57) ABSTRACT

In one aspect there is provided a block connector comprising a block member having at least one block port and at least one connection sub. The connection sub has a pipe connection end and a block connection end. The block connection end is threadably connectable to the bore port. In another embodiment of the invention there is provided a block connector comprising a block member having a plurality of block ports and at least one block bore. A plurality of wear sleeves are positionable within the at least one block bore, and said wear sleeves are secured within said at least one block bore.

### CROSS REFERENCE TO RELATED APPLICATION

This application is a non-provisional application which claims priority to, and benefit of, U.S. Provisional Patent Application Ser. No. 63/428,726 filed Nov. 29, 2022 and entitled, “FRACING SYSTEM WITH THREADED BLOCK CONNECTOR AND VARIABLE LENGTH CONNECTOR”, the entirety of which is incorporated herein by reference.

### FIELD OF THE INVENTION

This invention relates generally to well fracturing systems used in oil and gas exploration and production operations and, in particular, to a well fracturing system that is axially, variably adjustable, has a reduced need for conventional studded connections, and has improved wear resistance.

### BACKGROUND OF THE INVENTION

The background information discussed below is presented to better illustrate the novelty and usefulness of the present invention. This background information is not admitted prior art.

Oil and gas exploration requires complex industrial equipment to be interconnected at a well site in a precise manner. Typically, a drilling rig and wellhead is connected to a pump of some type to drive drilling operations. A particular site may have numerous wells that are drilled. To improve subsequent production at these sites, fracturing fluids may be pumped down these wells to fracture subterranean rock layers and thereby free oil and natural gas. This process is commonly referred to as hydraulic fracturing or fracing. Hydraulic fracturing produces fractures in the rock formation that stimulate the flow of natural gas or oil, increasing the volumes that can be recovered from a well.

Fractures are created by pumping large quantities of fracturing fluids at high pressure down a well and into the target rock formation. The fracturing fluid creates pressure within the well as the fluid accumulates, until the pressure causes cracks to form in the earth, or causes existing cracks in the earth to widen, thereby increasing the flow of hydrocarbons from the well. A proppant is often added to the fracturing fluid to keep an induced hydraulic fracture open. A proppant is a solid material, typically sand, treated sand or man-made ceramic materials, designed to keep an induced hydraulic fracture open, during or following a fracturing treatment. Chemical additives that also assist in opening and enlarging fractures within the rock formation may also be added to the fracturing fluid.

Hydraulic fracturing requires specialized equipment to pump fracturing fluids and any proppants, at varying pressures, to the wells via wellheads. This is conventionally done by a pump supplying fracturing fluids and any proppants to the wellhead for selective delivery down the well. These fracturing fluids are conveyed from pumps to wellheads using interconnected mechanical networks of piping, commonly referred to as fracturing fluid conduits, which typically include one or more fracturing manifolds; e.g. a pumping manifold, a flowback manifold, a choke manifold, and other manifolds. In essence, the fracturing fluid conduits must provide flow paths for varying degrees of pressurized fracturing fluids and/or varying degrees and types of proppants.

The wellheads may each use a fracturing tree and other components to facilitate a fracturing process and enhance production from a well. A fracturing flow control unit may provide control of fracturing fluid flow from the fracturing fluid conduits into one or more fracturing trees positioned on their respective wellheads. The fracturing flow control unit may contain one or multiple valves that controls the flow of the fracturing fluid into the fracturing tree. The fracturing flow control units and fracturing trees are typically large and heavy, and may be mounted together at a fixed location, thereby making adjustments in the fracturing manifold connected between the fracturing flow control units difficult.

Additionally, the various manifolds must be installed at the wellhead surface, which can require six to eight hours, or longer, and numerous personnel. Connections between the various components of a fracturing fluid conduit are typically made via a flanged and/or studded connection, each of which typically has between 8 to 16 sets of nuts, studs, bolts and washers which require proper fastening and torquing to the required specification; see, for example, the studded and flanged connection system taught in U.S. Pat. No. 8,839,867.

Moreover, in wellsite having multiple wellheads, manifolds and fracturing trees, connection alignment issues often occur. U.S. Pat. No. 8,839,867 also discloses a fracturing fluid conduit where the conduit length is axially adjusted by an adjustment joint with a plurality of components using threaded parts, studs and nuts, and special sealing members to achieve a seal after the conduit adjustments are made. While this axially adjusted feature aids with overcoming alignment issues, it can still take a number of days to assemble the full fracturing fluid conduit system, especially in wellsite with multiple wellheads.

Another problem with existing well fracturing systems is that they tend to utilize block connectors, or blocks, to provide fluid communication between the various fracturing fluid conduit components, including any fracturing fluid flow control units on fracturing trees. These blocks may have two, three, four or more connections, and they may be arranged in a conventional manner to diverge or converge fracturing fluids when such fluids are directed to/from the wellheads. However, if the fracturing fluids contain proppant or chemical additives, the internal fluid paths of these blocks is subject to significantly increased wear and damage; especially when the blocks are configured to change direction of the fracturing fluid (e.g. a 90 degree turn in the fluid path, or a three-way block that diverges a single incoming hydraulic fluid path into two outgoing fluid paths).

Therefore, what is needed is a fracturing fluid conduit system that does not suffer from these disadvantages.

### SUMMARY OF THE INVENTION

In an embodiment of the invention there is provided a block connector comprising a block member having at least one block port and at least one connection sub. The connection sub has a pipe connection end and a block connection end. The block connection end is threadably connectable to the bore port.

In another embodiment of the invention there is provided a block connector comprising a block member having a plurality of block ports and at least one block bore. A plurality of wear sleeves are positionable within the at least one block bore, and said wear sleeves are secured within said at least one block bore. In yet another embodiment of the invention there is provide a block connector comprising a block member having at least one block port and at least one connection sub having a pipe connection end. The pipe connection end has a threaded section for threadably connecting to pipes or other fracturing fluid conduits.

### BRIEF DESCRIPTION OF THE DRAWINGS

Referring to the drawings, several aspects of the present invention are illustrated by way of example, and not by way of limitation, in detail in the figures, wherein:

FIG. 1A is a top perspective view of a fracing system with threaded block connector and variable connector in accordance with one embodiment of the present invention;

FIG. 1B shows an enlarged view of the encircled portion labelled A shown in FIG. 1A;

FIG. 2A is a side view of the fracing system with threaded block connector and variable connector of the embodiment of FIG. 1A;

FIG. 2B is a cross-sectional view of the fracing system with threaded block connector and variable connector taken along the line B-B of FIG. 2A;

FIG. 3 is a top view of the fracing system with threaded block connector and variable connector of the embodiment of FIG. 1A adjacent a well, tree and control unit;

FIG. 4A is a top perspective view of a preferred embodiment of a threaded block connector;

FIG. 4B is a front view of the threaded block connector of the embodiment of FIG. 4A;

FIG. 4C is a cross-sectional view of the threaded block connector taken along the line C-C of FIG. 4B;

FIG. 4D is a sectioned top perspective view of the threaded block connector of the embodiment of FIG. 4A;

FIGS. 4E-4F are sectioned top perspective views of some of the components of the threaded block connector of the embodiment of FIG. 4A;

FIG. 4G-4K are top perspective views of some of the components of the threaded block connector of the embodiment of FIG. 4A;

FIGS. 4L-4M are additional sectioned top perspective views of the threaded block connector of the embodiment of FIG. 4A;

FIG. 5A is a top perspective view of another preferred embodiment of a threaded block connector;

FIG. 5B is a front view of the threaded block connector of the embodiment of FIG. 5A;

FIG. 5C is a cross-sectional view of the threaded block connector taken along the line D-D of FIG. 5B;

FIG. 6A is a top perspective view of yet another preferred embodiment of a threaded block connector;

FIG. 6B is a front view of the threaded block connector of the embodiment of FIG. 6A;

FIG. 6C is a cross-sectional view of the threaded block connector taken along the line D-D of FIG. 6B;

FIG. 7A is a perspective view of a preferred embodiment of variable length connector;

FIG. 7B is a side view of the variable length connector of the embodiment of FIG. 7A;

FIG. 7C is a cross-sectional view of the threaded block connector taken along the line E-E of FIG. 6B;

FIGS. 8A-8C are perspective views of the variable length connector of the embodiment of FIG. 7A shown actuated between extended (FIG. 8A) and contracted (FIG. 8C) positions;

FIGS. 8D-8F are sectioned, perspective views of the variable length connector of the embodiment of FIG. 7A shown actuated between extended (FIG. 8D) and contracted (FIG. 8F) positions;

FIG. 9A is a perspective view of a preferred embodiment of a variable length connector positioned adjacent a preferred embodiment of a threaded block connector, ready to make a threaded connection therebetween;

FIG. 9B is a perspective view of the variable length connector of FIG. 9A partially, threadably connected to the threaded block connector of FIG. 9A; and

FIG. 9C is a perspective view of the variable length connector of FIG. 9A threadably connected to the threaded block connector of FIG. 9A;

FIGS. 9D-9F are sections perspective views of the variable length connector and threaded block connector of the embodiments of FIGS. 9A-9C respectively;

FIG. 10A is a top perspective view of yet another preferred embodiment of a threaded block connector;

FIG. 10B is a front view of the threaded block connector of the embodiment of FIG. 10A;

FIG. 10C is a cross-sectional view of the threaded block connector taken along the line F-F of FIG. 10B;

FIG. 10D is a sectioned top perspective view of the threaded block connector of the embodiment of FIG. 10A;

FIGS. 10E-10F are partially exploded perspective and sectioned perspective views, respectively, of the threaded block connector of the embodiment of FIG. 10A;

FIGS. 10G-10H are section perspective views of the threaded block connector of the embodiment of FIG. 10A;

FIGS. 11A-11B are perspective views of an embodiment of wear sleeves;

FIGS. 12A-12B are perspective views of an embodiment of a block connector;

FIGS. 12C-12D are partially exploded, and partially exploded and partially sectioned, perspective views of the block connector of FIG. 12A; and

FIG. 12E is a section perspective view of the block connector of FIG. 12A.

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

Additionally, to assist in the description of the invention, words such as top, bottom, upper, lower, above, below, front, rear, right and left are used to describe the accompanying figures. It will be appreciated, however, that the present invention can be located and positioned in a variety of desired positions and angles, and that the various components can be arranged in other suitable configurations. The terms “comprising,” “comprises,” “including,” “includes,” “having,” “haves,” and their grammatical equivalents are used herein to mean that other components, elements or steps are optionally present.

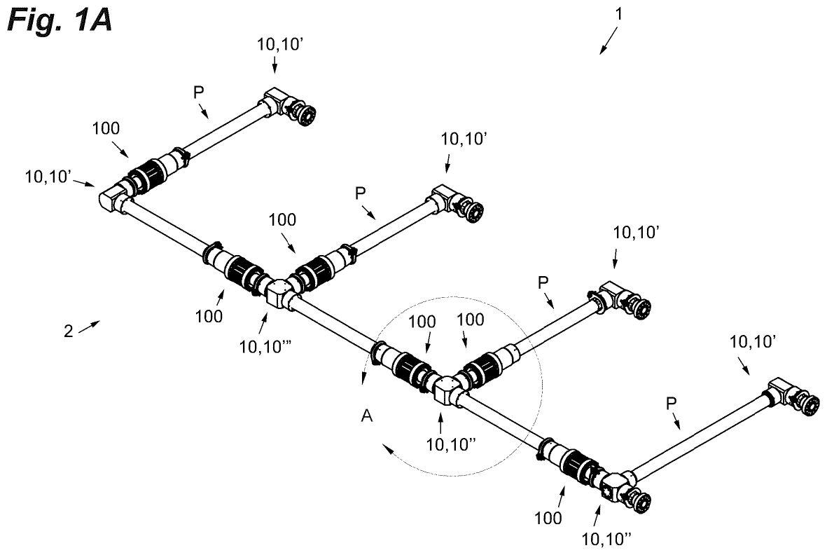

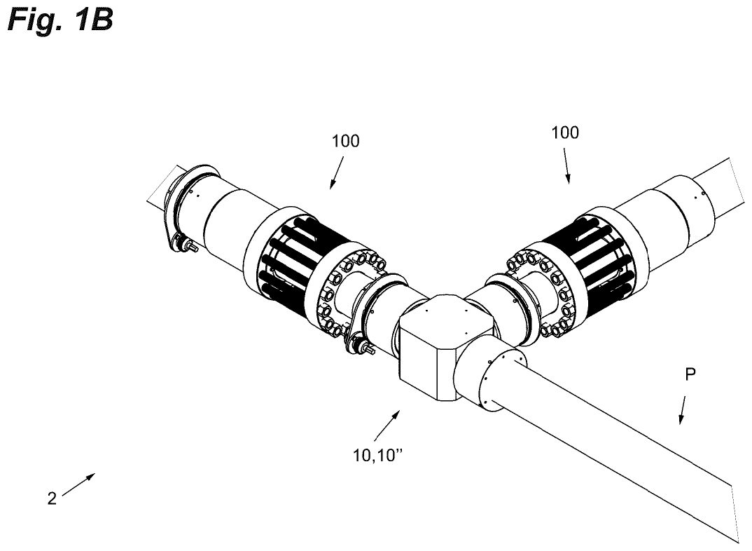

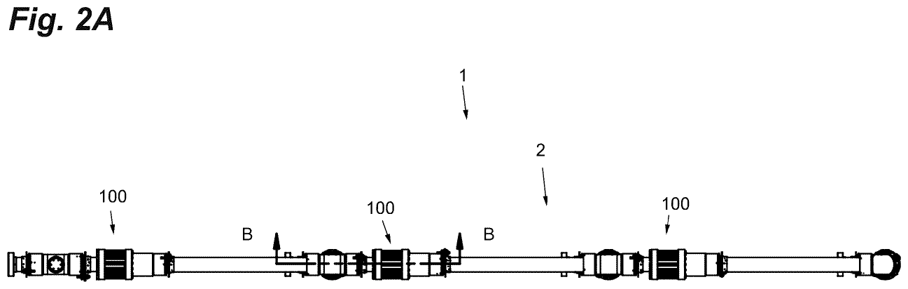

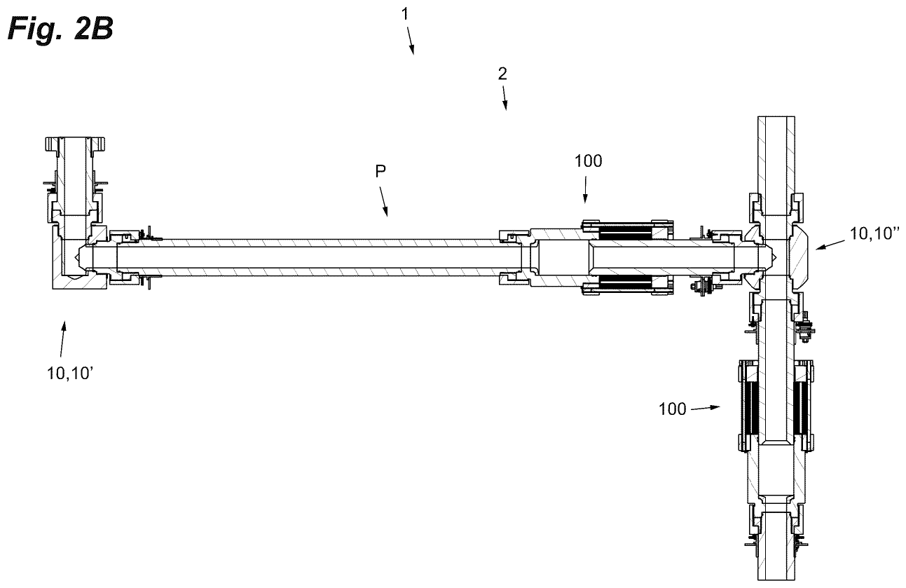

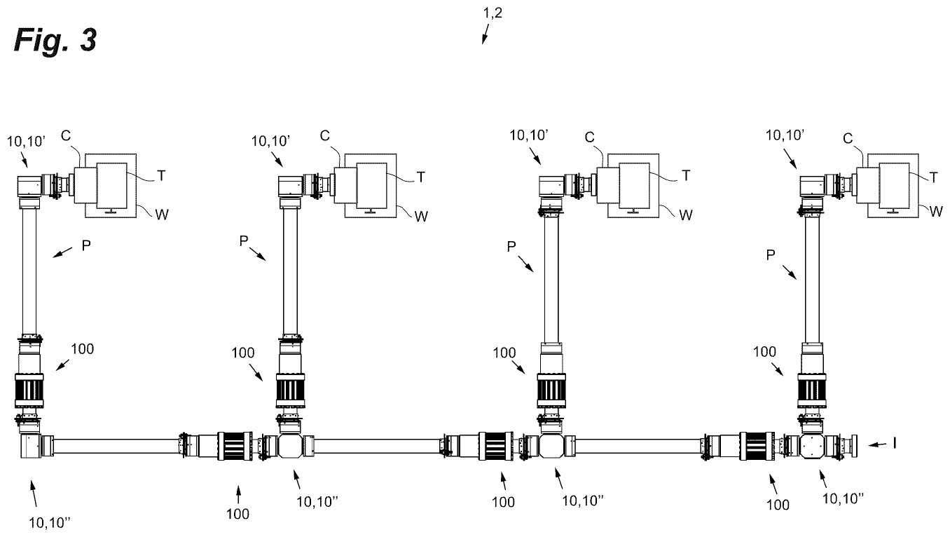

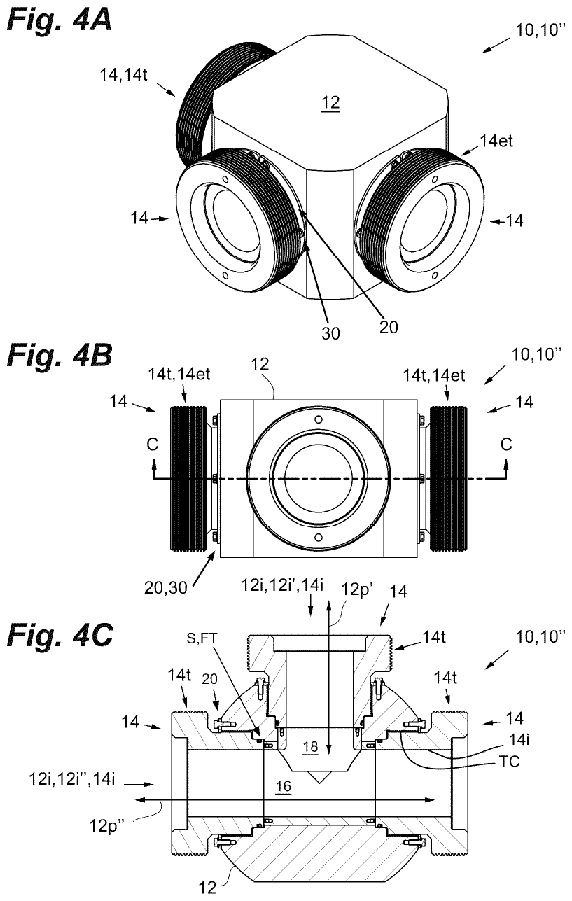

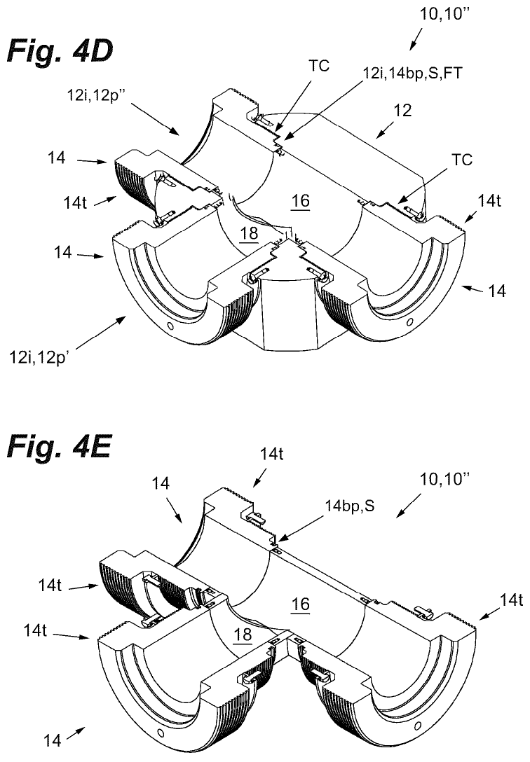

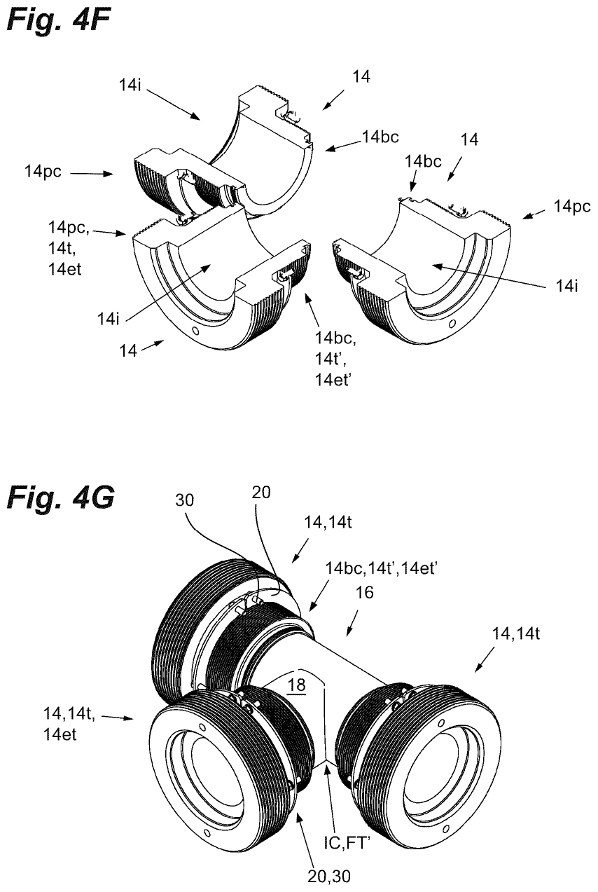

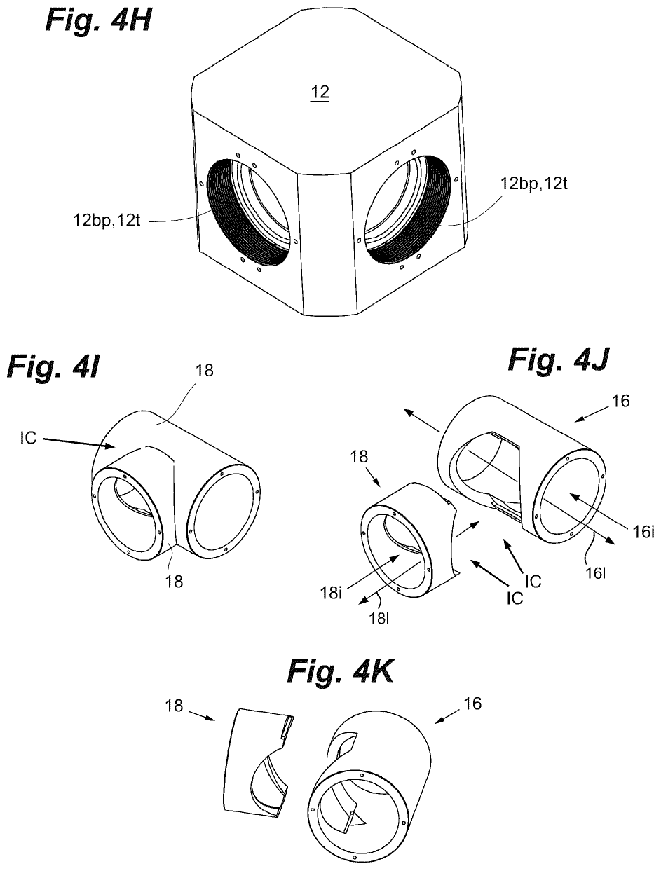

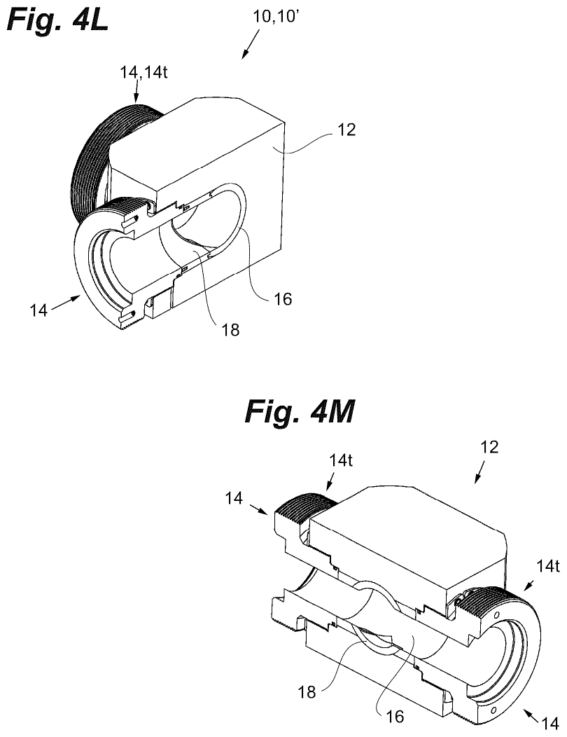

A first embodiment of a fracing system 1 with threaded block connector 10 and variable connector 100 of the present invention is shown in FIGS. 1A-3. Various components of the fracing system 1 with threaded block connector 10 and variable connector 100 are shown in FIGS. 4A-7C.

The fracing system 1 comprises a fracturing fluid conduit 2, at least one threaded block connector 10 and at least one variable connector 100. The fracturing fluid conduit 2, along with the threaded block connectors 10 and variable connectors 100, provides flow paths for varying degrees of pressurized fracturing fluids and/or varying degrees and types of proppants from a source of pressurized fluid (not shown), through to one or more wellheads W. The source of pressurized fluid (not shown) is preferably connected to an inlet I of the fracturing fluid conduit 2 in a conventional manner. The fracturing fluid conduit 2 may comprise sections of tubular conduits, such as pipes P that are threadably connected between the threaded block connectors 10 and variable connectors 100.

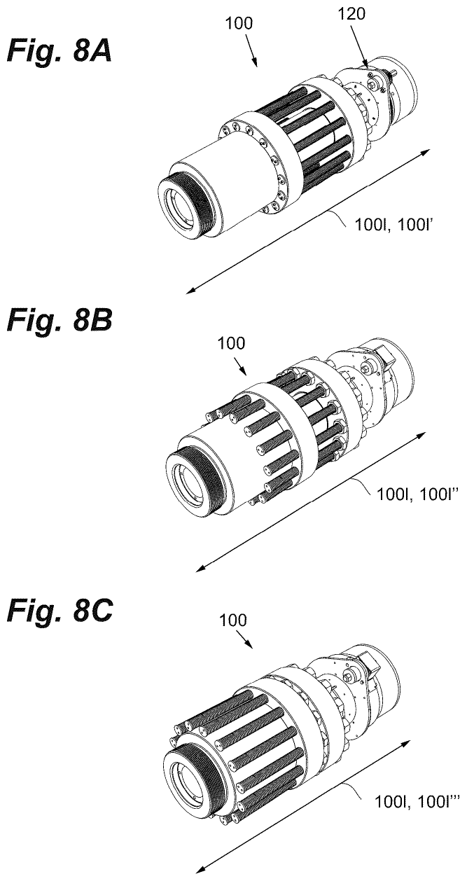

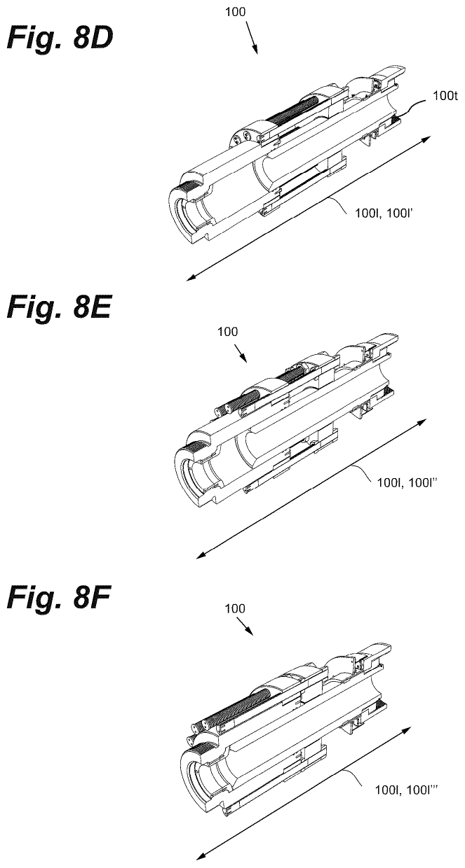

Variable connectors 100 preferably telescope or adjust along a longitudinal axis 1001 between an extended position (see FIG. 8A) having a first length 100l′, a middle position (see FIG. 8B) having a second length 100l″ and a contracted position (see FIG. 8C) having a third length 100l″. As can be seen, first length 100l′ is longer than second length 1001″, and second length 100l″ in turn is longer than third length 100l″. The variable connector 100 can actuate between extended position and contracted position, by means of actuator 120 (such as a rotary actuator), and thereby adjust to various lengths as may be desired between first length 100l′ and third length 1001″.

The wellheads W may each use a fracturing tree T and other components to facilitate a fracturing process and enhance production from a well. A fracturing flow control unit C may provide control of fracturing fluid flow from the fracturing fluid conduit 2 into one or more fracturing trees T positioned on their respective wellheads W.

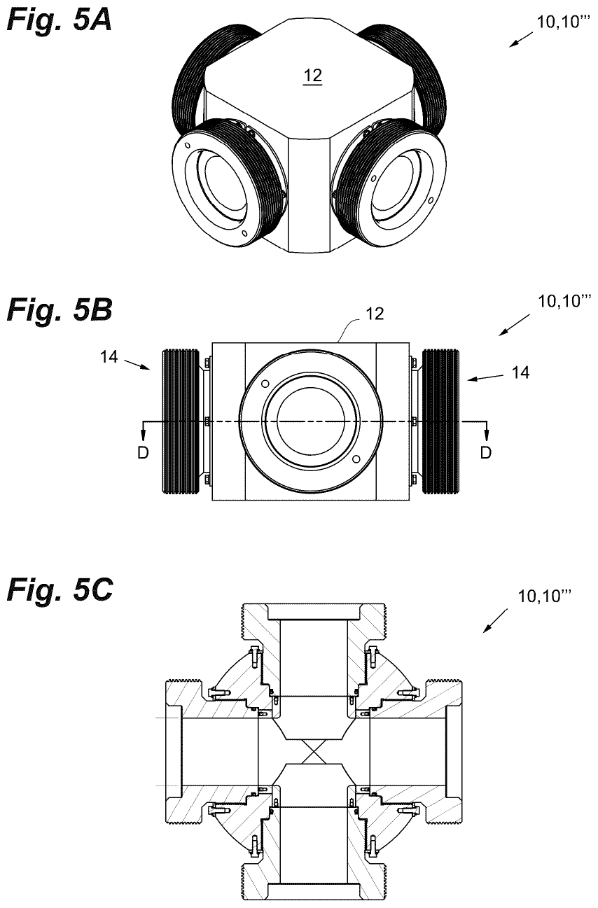

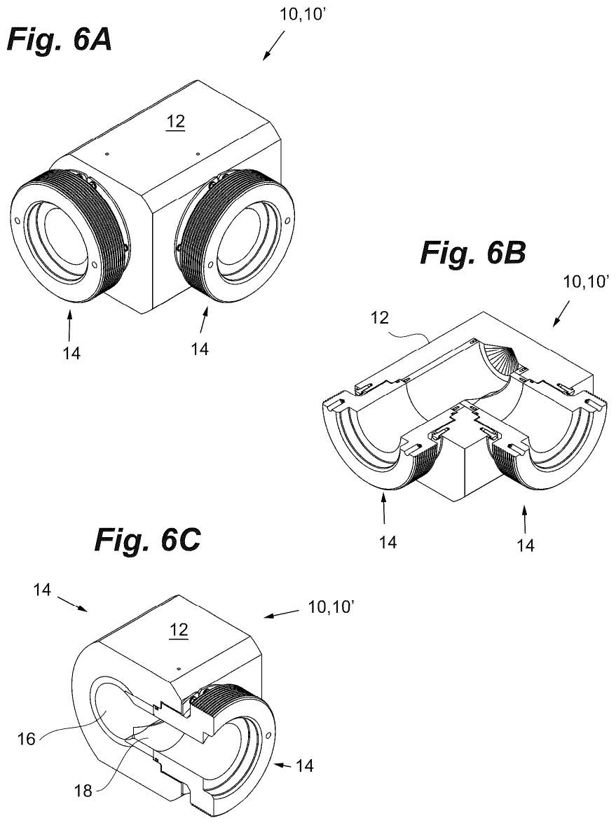

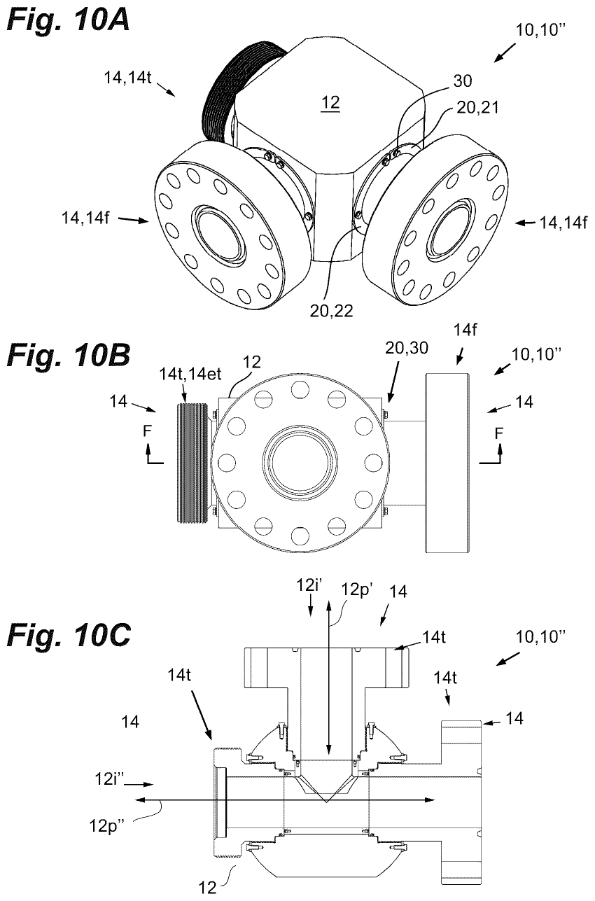

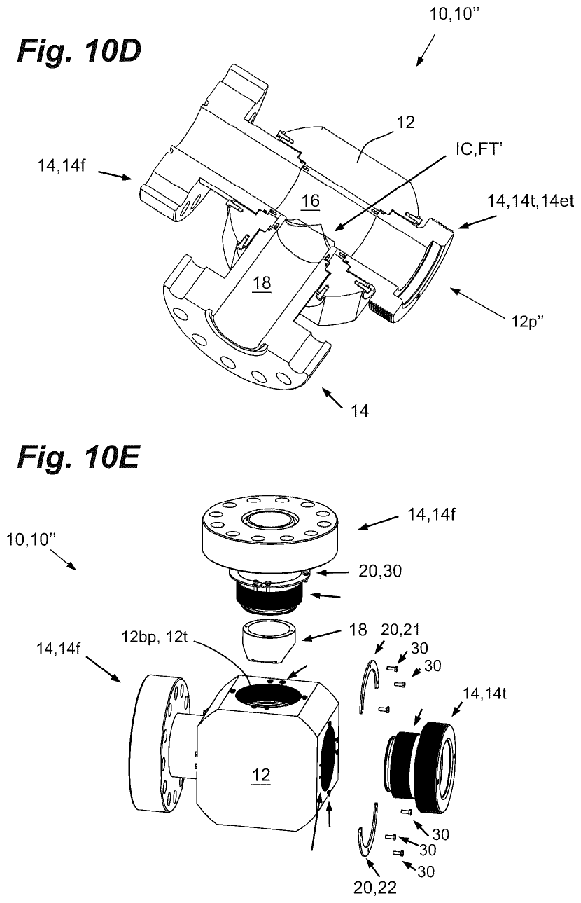

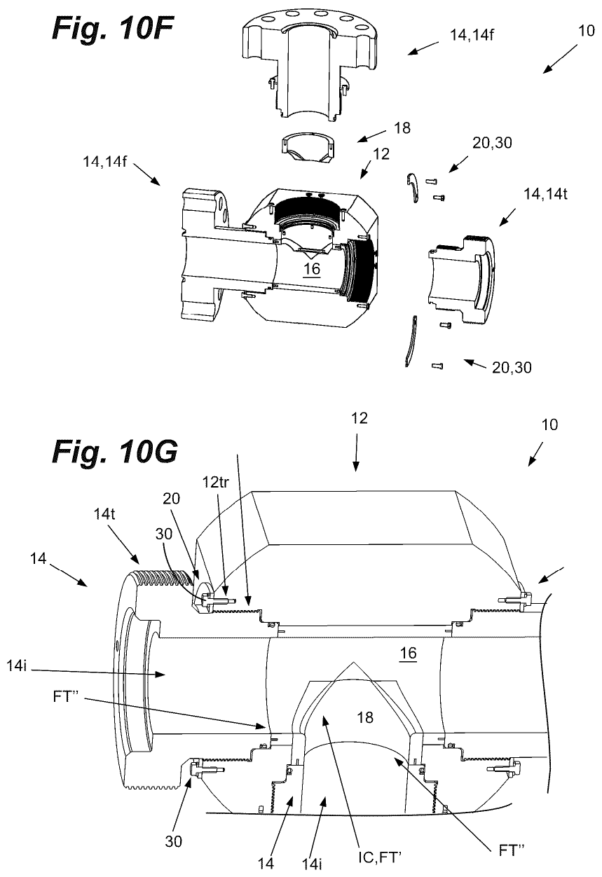

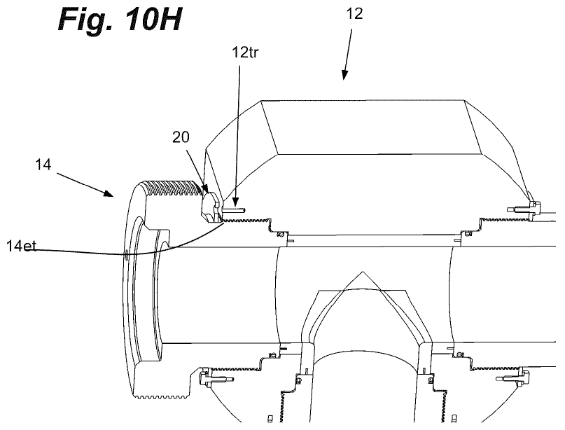

The threaded block connectors or blocks 10 can be understood with reference to FIGS. 4A-6C. A preferred embodiment of a three-way block connecter 10″ is shown in FIGS. 4A-4M. A preferred embodiment of a four-way block connecter 10′″ is shown in FIGS. 5A-5C. A preferred embodiment of a two-way block connecter 10′ is shown in FIGS. 6A-6C. Another preferred embodiment of a three-way block connecter 10″ is shown in FIGS. 10A-10H.

The threaded block connector 10 preferably comprises a base block member 12 and one or more connection subs or unions 14, each sub 14 having a sub bore or internal passage 14i to conduct fracing fluids through sub 14 (as is conventional), a conduit or pipe connection end 14pc and a block connection end 14bc (see FIG. 4F). Pipe connection end 14pc preferably comprises an outwardly projecting threaded end or threaded section 14t (e.g. as shown in FIGS. 4A-4G), although other conventional pipe connections may be provided at pipe connection end 14pc (e.g. see flanged end 14f in FIGS. 10A-10F).

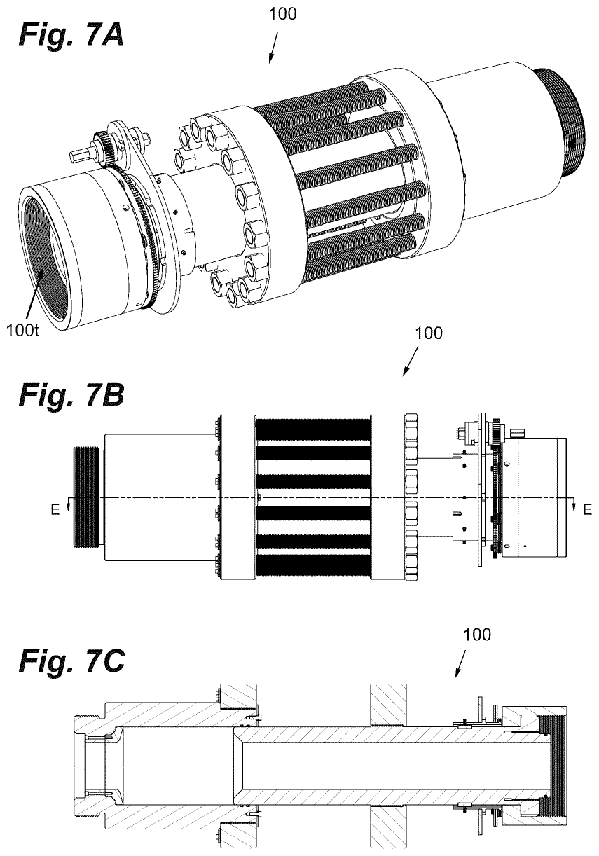

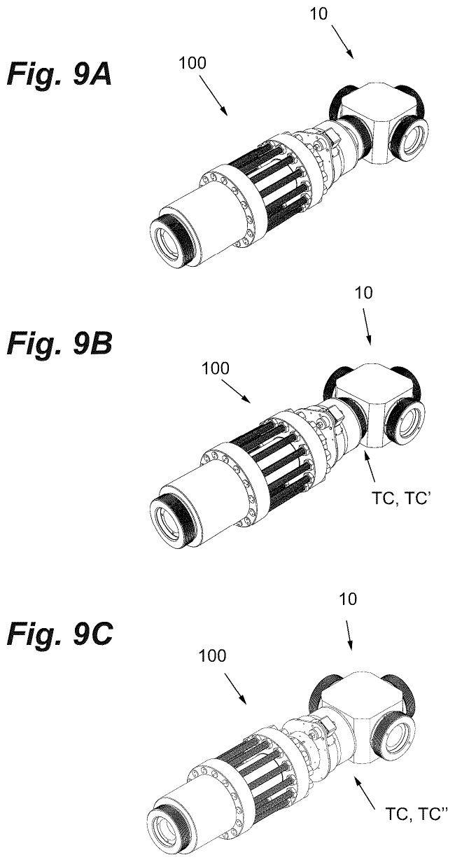

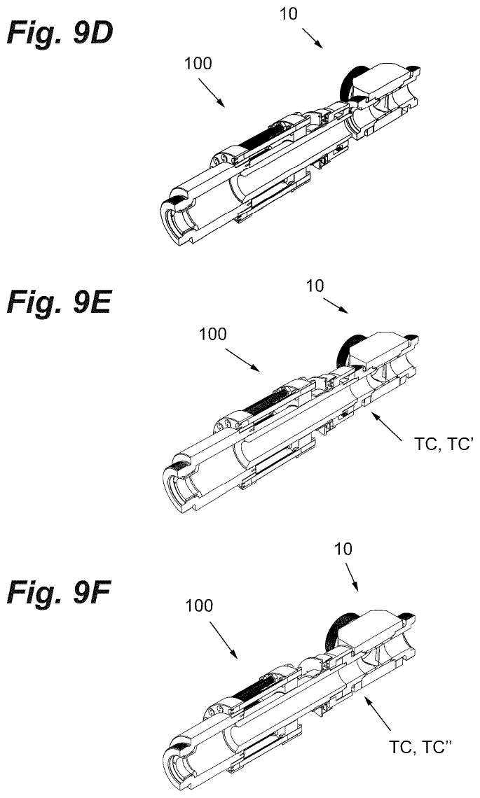

Threaded section 14t is preferably externally threaded 14et and is connectable to internal threads of tubular conduits or pipes P and/or internal threads 100t of the variable connectors 100 (see FIG. 7A) to make a sealed, threaded connection TC between the connection sub 14 and the variable connector 100 and/or the fracturing fluid conduit 2 (e.g. the pipes P). See, for examples FIGS. 9A-9C. FIG. 9A illustrates a variable length connector 100 positioned adjacent a block 10, ready to make a threaded connection therebetween. FIG. 9B shows the variable length connector 100 partially, threadably connected TC′ to the block connector 10. FIG. 9C shows the variable length connector 100 fully sealed and threadably connected TC″ to the threaded block connector of FIG. 9A. In another embodiment (not shown), connection sub or union 14 may also have an internally threaded section (not shown) threadably connectable to the external thread of tubular conduits or pipes.

In yet another embodiment, e.g. as shown in FIGS. 10A-10F, the block 10 has a plurality of connection subs or unions 14 wherein the pipe connection ends 14pc comprises a mixture of flanged connections 14f and threaded connections 14t. For example, the embodiment of FIGS. 10A-10H has two subs 14 that have a flanged connection 14f, and a third sub 14 that has a threaded connection 14t with an externally threadable connection 14et. Advantageously, a block 10 with a mixture of flanged connections 14f and threaded connections 14t can be used in a retro-fit application, wherein some of the pipes P have flanged connections, and wherein other pipes P have threaded connections.

Base block member 12 (or block member) preferably comprises one or more block bores or internal passage 12i to conduct fracing fluids through block 10, as is conventional with traditional block connectors. When assembled, the internal passages 12i of the block member 12 align with the internal passages 14i of the subs 14 to provide a fluid communication passage for fracing fluid through the block 10 as is conventional (e.g. see FIG. 4C). Block bores 12i may be axially misaligned relative to each other, while still fluidly connected to each other, to facilitate angled connection of the various components (e.g. pipes P) of the fracturing fluid conduit 2; e.g. a first block bore 12i′ in FIG. 4C has a longitudinal bore axis 12p′ that is at a substantially 90 degree angle relative to longitudinal bore axis 12p″ of a second block bore 12i″.

As is conventional, the base block member 12 is provided with bore or block ports 12bp to allow entry and exit of fracing fluids into and out from the block 10 via bore passages 12p′, 12p″, and to which high-pressure lines (e.g. pipes P) can be connected and through which pressurized fracturing fluids can then be pumped in a conventional manner. As is known in the art, the fracturing fluids include a slurry of treatment fluids and abrasive proppants which block connector 10 conducts to other components of the fracing system 1, such as to the fracturing fluid conduit 2.

Block connection end 14bc of the connection sub 14 is preferably an outwardly projecting threaded end having threaded section 14t′ (e.g. as shown in FIGS. 4F-4G). Threaded section 14t′ is preferably an externally threadably section 14et′ that is threadably connectable to a bore port 12bp having a corresponding internally treaded connection 12t, to make a fluid sealed, threaded connection TC between connection sub 14 and base block member 12 (see FIG. 4D).

Advantageously, connection subs 14 can be quickly and easily connected to, or disconnected from, the block member 12. More advantageously, different connection subs 14 can be quickly and easily substituted for existing connection subs 14 on a particular block 10 (e.g. a connection sub 14 having a threaded end 14t can be swapped out and replaced with a connection sub 14 having a flanged end 14f).

Preferably one or more wear-resistant inserts or sleeves 16, 18 are provided to line the interior surface of the various internal passages 12i of a base block member 12, said sleeves 16, 18 being of generally hollow tubular configuration, having an outside diameter of sufficient dimensions and tolerances to fit snugly inside internal passages 12i, and having an internal diameter of sufficient dimensions to communicate fracturing fluids through the base block member 12. The wear-resistant inserts (or “sleeves”) and any associated annular sealing elements (not shown) can be secured within one or more block bores 12i in the block connector 10 in order to provide a wear-resistant flow-path lining that inhibits erosion of the base block member 12 and thus prolongs the service life of the block connector 10. Preferably, sleeves 16, 18 are of such dimensions that they can be inserted into internal passages 12i of block member 12 via one or more of the block ports 12bp (e.g. see FIG. 10E).

As shown in FIGS. 4C, 4D, 4E and 10D, a first insert 16 is positioned in the second block bore 12i″, while a second insert 18 is positioned in first block bore 12i′. When a block 10 of the present invention is fully assembled, subs 14 abut against the sleeves 16, 18 to capture and keep them secured inside block member 12. Subs 14 also preferably provide a fluid-tight seal FT to the block bores 12i (e.g. via the threaded connection TC and an o-ring or other conventional seal S positioned between the sub's block connection end 14bc and a surface or shoulder on the internal passage 12i), i.e. to contain any fluid pressure within inside passages 12i, 14i and isolate such pressure from the external atmosphere. Preferably subs 14 have internal passage 14i wherein their internal profile matches the internal profile of the respective internal passage 16i, 18i of sleeves 16, 18 to which subs 14 abut.

Preferably, wear inserts 16, 18 are made out of durable and hardened material. More preferably, wear inserts 16, 18 have an internal surface geometry that allows for smooth fluid flow around corners. Even more preferably, wear inserts 16, 18 have mating ends 16m, 18m that mate together in an interlocking configuration IC. When sleeves 16, 18 are assembled within the block connector 10, and captured by the block connection ends 14bc of the subs 14, the interlocking configuration IC provides a fluid-tight seal FT′ between the sleeves 16, 18 (e.g. a metal-to-metal seal; see FIG. 10D) and prevents rotation of the sleeves 16, 18 within the bores 12i. Since, preferably, subs 14 provide a fluid-tight seal FT to the block bores 12i via seal S, there is typically minimal differential pressure between the internal passages 16i, 18i of the sleeves 16, 18, and any annular space between the outside diameter of the sleeves 16, 18 and the block bores 12i. As such, a interlocking configuration IC where the seal is a metal-to-metal seal of the respective sleeve surfaces is sufficient to prevent frac fluid from entering such annular space.

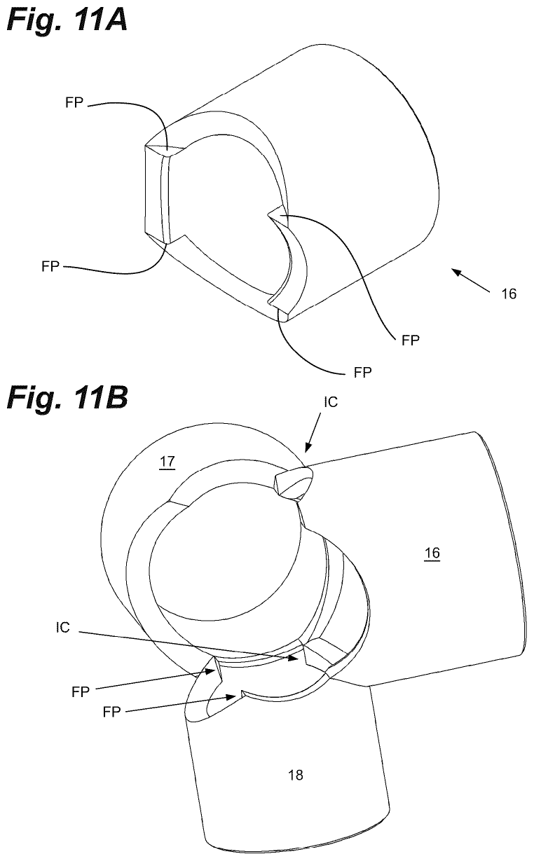

Interlocking configuration IC may be one of a number of different geometries (including those as shown in the figures) whereby wear sleeves 16, 18 are prevented from rotating about their longitudinal axis 161, 181 (e.g. see FIG. 4J). In a preferred embodiment of an interlocking configuration IC, as shown in FIGS. 11A-11B, each of the sleeves 16, 17, 18 in that embodiment that mate together comprises a flat or planar portion FP that abuts or mates against a corresponding flat or planar portion FP of the other sleeve(s), thereby preventing rotation of the sleeves 16, 17, 18 when assembled within their respective bores 12i or the block member 12. If sleeves 16, 17, 18 rotate within the bores 12i, then the fluid-tight seal FT′ between them may be compromised and/or misaligned and/or the internal flow-path of the sleeves' internal passage 16i, 18i may be compromised. This is especially of concern where a first block bore 12i′ has a longitudinal bore axis 12p′ that is at a substantially offset (e.g. 90 degree angle) relative to longitudinal bore axis 12p″ of a second block bore 12i″ (see FIG. 4C) and where the diameter of such offset sleeves 16, 18 are substantially the same (e.g. both sleeves 16, 18 have an outside diameter of 5 inches).

Advantageous, in the embodiments of the present invention any wear due to fracturing fluids is first imparted onto the interior surface of the wear inserts 16, 18. Should such wear become sufficient, connection subs 14 may be quickly and easily untreaded from the block member 12, wear inserts 16, 18 removed and replaced with new wear inserts, and then connection subs 14 rethreaded back into the block member 12 to capture the new wear inserts.

In a preferred embodiment of the block 10, sub retaining members 20 are provided to retain connection subs 14 in threaded connection with the bore ports 12bp once connection subs 14 are fully treaded into said block ports 12bp. Sub retaining members may be a planar member configured in a semi-circle shape of such diameter to be positioned around snugly around the collar 14c of the sub 14, and have a sufficiently small arc diameter to, once installed on block member 12, to abut against externally threaded section 14et′ of the block connection end 14bc, thereby keeping sub 14 from moving relative to block member 12. Preferably a sub retaining member fastener 30 (such as screw or stud) fastens sub retaining member 20 to the block member 12 (e.g. into a treaded recess 12tr in block member 12). See FIGS. 10G-10H. Advantageously, when fully assembled the sub retaining member 20, and sub retaining member fasteners 30, keep subs 14 from untreading out of block member 12.

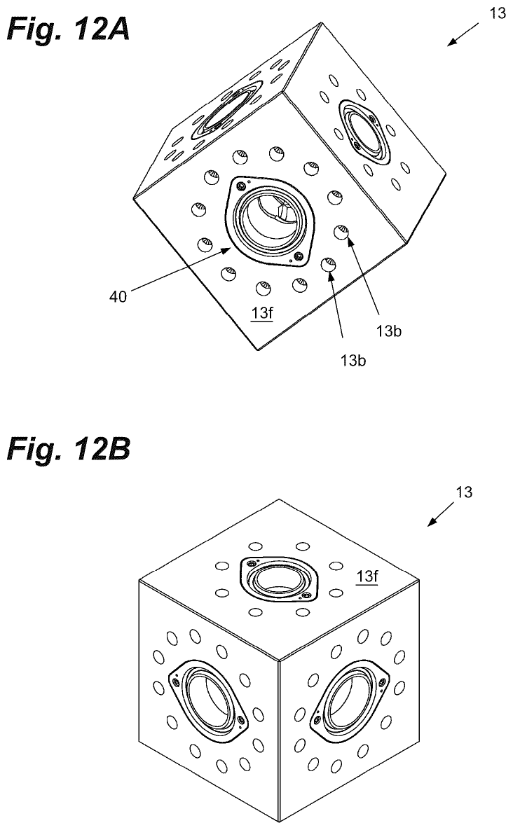

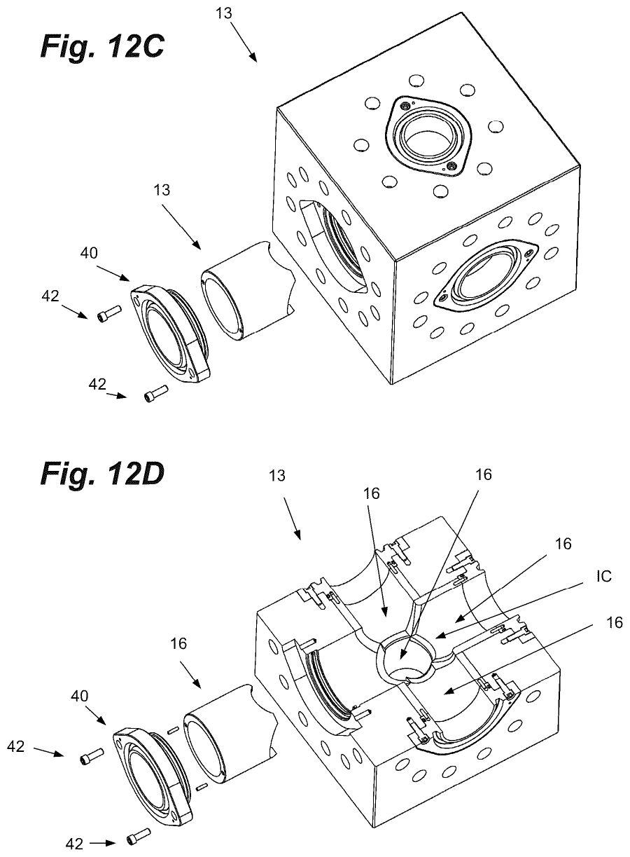

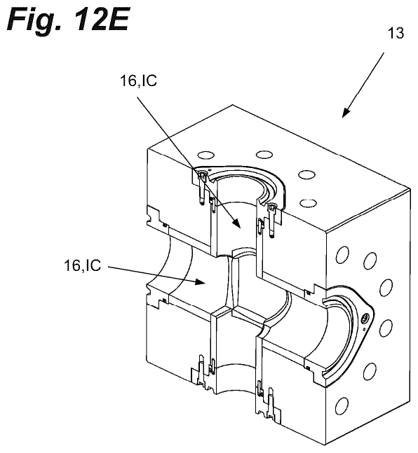

Another embodiment of a block connecter 13 having interlocking wear inserts 16 is shown in FIGS. 12A-12E. This embodiment of block 13 is a six-way block, having six block bores or passages 13i lined each with a wear insert 16 as shown. Instead of having a sub 14 with either a threaded or flanged end, this block 13 features a planar face 13f with treaded bores 13b to create a conventional studded connection. Sleeve retaining members 40 are provided at each of the relevant bore ports 13bp to: (i) retain sleeves 16 within their respective bore passage 13i (as shown), and (ii) provide a conventional sealing profile 40sp to accept a sealing member (not shown) and sealable mate with a flanged connection of a pipe or other member from the fluid conduit 2. Preferably conventional retaining member fasteners 42 (e.g. studs threadable in to corresponding threaded bores) may be provided to prevent sleeve retaining members 40 from disengaging from block 13 (e.g. prior to block 13 connecting with a flanged connection). When fully assembled, and as shown, sleeves 16 mate together to create an interlocking configuration IC in a similar manner as the other embodiments of block 10 noted above.

Exemplary materials used in the construction of the disclosed embodiments include high strength alloy steels, high strength polymers, and various grades of elastomers, seals and o-rings. Those skilled in the art will understand that, when the various threaded connections are fully connected, they form a fluid-tight sealed connection between the components suitable to withstand the typical pressures and temperatures encountered in a hydraulic fracturing operation.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

1. A block connector (10) comprising:
a block member (12) having at least one block port (12bp); and
at least one connection sub (14) having a pipe connection end (14pc) and a block connection end (14bc);
wherein said block connection end (14bc) is threadably connectable to said bore port (12bp).

2. The block connector (10) of claim 1 wherein the block connection end (14bc) further comprises a threaded section (14t′) having an externally threadable section (14et′);
wherein the at least one block port (12bp) further comprises an internally treaded connection (12t); and
wherein the externally threadable section (14et′) is threadably connectable to the internally threaded connection (12t).

3. The block connector (10) of claim 1 wherein the at least one connection sub (14) further comprises a pipe connection end (14pc) having a threaded section (14t).

4. The block connector (10) of claim 3 wherein the threaded section (14t) is externally threaded.

5. The block connector (10) of claim 1 wherein the at least one connection sub (14) further comprises a pipe connection end (14pc) having a flanged end (14f).

6. The block connector (10) of claim 1 wherein there are a plurality of connection subs (14) each further comprising a pipe connection end (14pc); and
wherein some of said plurality of connection subs (14) have a flanged end (14f) at said pipe connection end (14pc); and
wherein some of the remainder of said plurality of connection subs (14) have threaded end (14t).

7. The block connector (10) of claim 2 further comprising sub retaining members (20).

8. The block connector (10) of claim 7 wherein the sub retaining members (20) abut against the externally threadable section (14et′).

9. A block connector (10) comprising:
a block member (12) having a plurality of block ports (12bp) and at least one block bore (12i);
a plurality of wear sleeves (16) positionable within said at least one block bore (12i);
wherein said wear sleeves (16) are secured within said at least one block bore (12i).

10. The block connector (10) of claim 9 wherein the wear sleeves (16) are secured within the at least one block bore (12i) by a connection sub (14).

11. The block connector (10) of claim 9 wherein the wear sleeves (16) are secured within the block bore (12i) by a sleeve retaining member (40).

12. The block connector (10) of claim 9 wherein the wear sleeves (16) further comprise mating end that mate together in an interlocking configuration (IC) to provide a fluid-tight seal (FT′) between said wear sleeves (16).

13. The block connector (10) of claim 9 wherein the wear sleeves (16) further comprise mating end that mate together in an interlocking configuration (IC) to prevent rotation of said wear sleeves (16) within said at least one block bore (12i).

14. A block connector (10) comprising:
a block member (12) having at least one block port (12bp); and
at least one connection sub (14) having a pipe connection end (14pc);
wherein said pipe connection end (14pc) having a threaded section (14t).
